(19) United States
(12) Patent Application Publication
(10) Pub. No.: US 2009/0279379 A1
(43) Pub. Date: Nov. 12, 2009

(54) Blender for containerized products

(76) Inventor: John J. Gurney, Douglas, AZ (US)

Correspondence Address: HERBERT G. HAYNES JR, 2383 GLENVIEW DR., SIERRA VISTA, AZ, 85650, US

(21) Appl. No.: 12/151,366

(22) Filed: May 7, 2008

(51) Int. Cl. B28C 1/16; B01F 13/00

(52) U.S. Cl. 366/92; 366/198

(57) ABSTRACT

A blender mechanism for applying a mixing action on containerized non-homogenized products. The blender mechanism includes a housing having a drive roller and an idler roller with the rollers being mounted in spaced apart parallel relationship with respect to each other and disposed in a substantially horizontal attitude. A drive assembly is coupled to the drive roller for rotational driving thereof and the drive assembly preferably includes a variable speed electric motor which is coupled through a gear train to the drive roller. The housing and idler roller are configured so that the idler roller can be moved to increase the spacing between the idler and drive rollers to accommodate larger sizes of containerized products. Also, an additional idler roller can be installed in parallel spaced relationship with the first idler roller so that a second containerized product to be mixed can be supported upon the spaced apart idler rollers.

### BACKGROUND OF THE INVENTION

1. Field of the Invention

This invention relates to blenders and more particularly to a blender for mixing containerized products of the type which in the absence of any mixing action will separate into their respective ingredients.

2. Description of the Prior Art

Blenders of the type commonly found in domestic kitchens for mixing food or liquid ingredients normally include a container for receiving the ingredients to be mixed and motor driven mixing implements such as beaters or rotary blades extend into the ingredients and are driven to mix those ingredients. A typical blender of this type is disclosed in U.S. Pat. No. 2,913,230.

Another type of blender is a commercial apparatus which may be described as a materials feeding and blending mechanism. Such mechanisms usually include an elongated tube having an inlet end for receiving the materials to be blended and an outlet end for discharging the blended materials. The tube is of an undulating or zigzag configuration and is rotatably driven to produce a tumbling action which mixes the materials as they move through the tube. A typical blender of this type is disclosed in U.S. Pat. No. 3,341,182.

Blenders of the described type all have some portion of their mechanism, such as the beaters in the domestic appliance and the elongated tube in the commercial apparatus, in direct contact with the materials being mixed. Such blenders are not suited for mixing containerized products such as those packaged in cans, jars or bottles in that direct contact of the mixing elements with the ingredients is impossible in some cases and impractical in other cases.

A highly specialized blender for use with a specific containerized product is found in paint stores for mixing paint prior to its being sold. Blenders of this type employ a relatively violent shaking action and consume a large amount of energy and are therefore operated only for relatively short periods of time. Such blenders are unsuited for domestic use in mixing food or other products which do not require a violent mixing action or could be damaged thereby.

A particular product which inherently has a mixing problem is non-homogenized peanut butter which is often referred to as natural peanut butter. Prior to being used, the peanut oil which rises to the top of the container must be mixed into the peanut butter ingredient below the oil. Such mixing is often done by inserting a mixing element such as a table knife into the peanut butter jar and manually stirring the ingredients. The viscosity of peanut butter is such that manual stirring is not easy and very often the ingredients will spill over the side of the jar during the mixing operation. Such mixing will need to be repeated each time the peanut butter is to be used unless the time between uses is relatively short. To avoid repeated mixings, sometimes the peanut butter is refrigerated after being mixed, but this is less than ideal in that refrigerated peanut butter is difficult to spread.

To the best of my knowledge no blender has been devised or suggested which may be continuously or periodically operated to apply a relatively gentle mixing action on containerized non-homogenized products.

### SUMMARY OF THE INVENTION

In accordance with the present invention a new and useful blender mechanism is disclosed for applying a mixing action on containerized non-homogenized products. The blender mechanism includes a suitable housing having a drive roller and at least one idler roller with the rollers being mounted in spaced apart parallel relationship with respect to each other and disposed in a substantially horizontal attitude within the housing. A drive mechanism is mounted on the housing and is coupled to the drive roller for rotational driving thereof. The drive mechanism preferably includes a variable speed electric motor which is coupled through a gear train to the drive roller. The idler roller has an axel which is fixed against rotation and the roller body is free to rotate about its axel.

Operation of the blender mechanism described above is accomplished by placing the containerized product to be mixed atop the drive and idler rollers so that the containerized product is supported on and in bearing engagement with the rollers. Rotational driving of the drive roller by operation of the drive mechanism will impart a rotational movement on the containerized product and the rotational movement of the containerized product will in turn impart a rotational movement on the idler roller. Such rotating of the containerized product will cause a blending of the product ingredients.

The housing and idler roller are configured so that the idler roller can be moved to adjust the spacing between the idler and drive rollers to accommodate different sizes of containerized products. Also, an additional idler roller can be installed in parallel spaced relationship with the first idler roller described above so that a second containerized product to be mixed can be supported upon the spaced apart idler rollers. In this manner, the second containerized product will be rotated on the two idler rollers with the driving force being produced by the rotational driving of the first idler roller by the first containerized product.

Electrical operation of the variable speed electric motor is preferably accomplished by employing a step-down transformer/rectifier which is connected to a 120 VAC power source to reduce the voltage to 12 Volts and rectify it from AC to DC. The 12 VDC is coupled through a rheostat to the motor. In this manner the rotational speed of the drive roller can be adjusted to suit the viscosity of the ingredients being mixed by the blender mechanism and the power consumption is such that low cost continuous or part time operation of the mechanism can be economically employed.

It is therefore an object of the present invention to provide a new and useful blender mechanism for mixing the ingredients of containerized products.

### BRIEF DESCRIPTION OF THE DRAWINGS

FIG. 1 is a perspective view showing the various features of the blender mechanism in accordance with the present invention.

FIG. 2 is an enlarged sectional view taken along the line 2-2 of FIG. 1 and which is partially broken away to show the various features thereof.

FIG. 3 is an enlarged sectional view taken along the line 3-3 of FIG. 1 and which is partially broken away to show the various features thereof.

FIG. 4 is a fragmentary sectional view taken along the line 4-4 of FIG. 1, with a particular containerized product added to the view to show the relationship between the product and the blender.

FIG. 5 is a schematic diagram showing a power supply for use with the blender mechanism of the present invention.

FIG. 6 is a fragmentary sectional view similar to FIG. 4 showing a modification of the blender of the present invention.

### DESCRIPTION OF THE PREFERRED EMBODIMENT

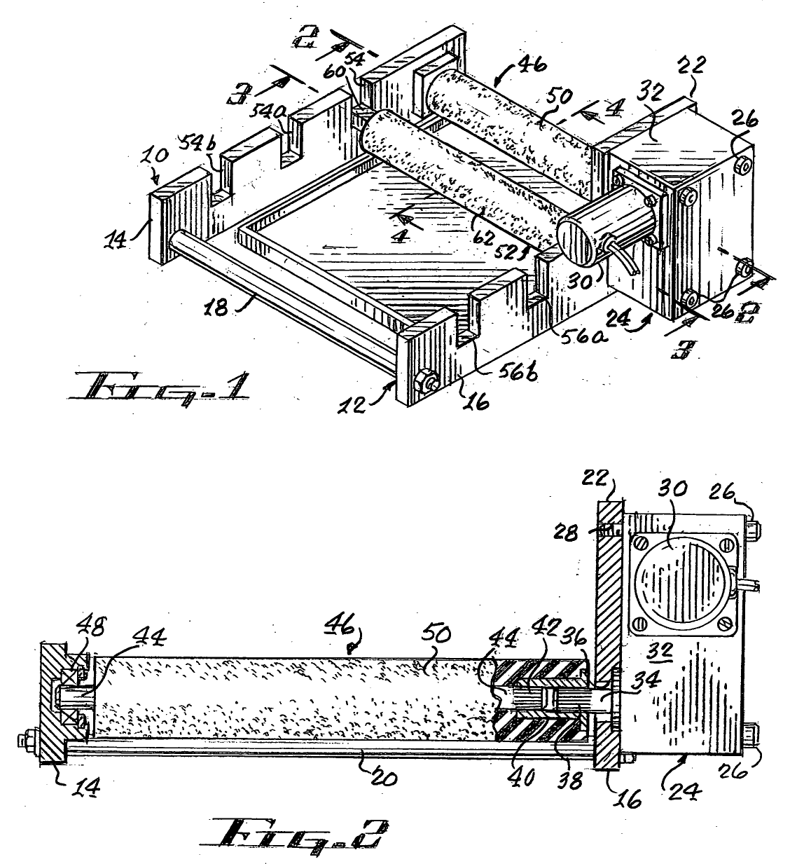

Referring more particularly to the drawings, FIG. 1 shows the blender mechanism of the present invention which is indicated generally by the reference numeral 10. To insure a clear understanding of the following description, two of the terms used herein will now be defined. The term containerized product is meant to include any product that is packaged within a closed container such as a can, bottle and the like. The term non-homogenized product relates to any product which, in the absence of a mixing action, will separate into its ingredients.

The blender 10 includes a housing 12 which has a spaced apart pair of side members 14 and 16 which are interconnected by suitable support rods 18 and 20. The side member 16 has an upstanding pad portion 22 to which a drive assembly 24 is mounted by screws 26 which are in threaded engagement with internally threaded bores 28 (one shown) formed in the pad portion.

The drive assembly 24 includes a variable speed drive motor 30 and a gear train 32 which is operational to produce a rotation on the output shaft 34 of the drive assembly 24. The drive assembly 24 preferably is a 12 VDC, 15 mA, 5 rpm gear motor and such a unit is manufactured by the TRW Corporation under item Number DCM-276 and is commercially available from the All Electronic Co. of 14928 Oxnard Street, Van Nuys, Calif. 91411.

As seen in FIG. 2, the output shaft 34 of the drive assembly 24 passes through an opening 36 provided in the pad portion 22 of the side member 16 and has splines 38 formed on its distal end. An internally splined coupler 40 is mounted on the output shaft 34 for connecting the output shaft to the splined end 42 of an axel shaft 44 of a drive roller 46 that is mounted in the housing 12. The opposite end of the axel shaft 44 is carried in a bearing 48 that is mounted in the side member 14. The drive roller 46 has a body 50 concentrically mounted on the axel shaft 44 for rotation therewith and the body is preferably made of rubber or other suitable material that will result in a relatively high coefficient of friction between the roller body 50 and the containerized product to be rotatably driven thereby as will hereinafter be described.

As seen in FIG. 1 an idler roller 52 is mounted so as to extend between the side members 14 and 16 of the housing 12 with the idler roller being spaced from and parallel with respect to the drive roller 46. The side member 14 of the housing 12 has a plurality of upwardly opening slots 54, 54a and 54b formed in spaced locations along the length thereof, and the opposite side member 16 is similarly provided with a plurality of upwardly opening square slots 56, 56a and 56b. The slots 54, 54a and 54b of the side member 14 are each transversely aligned with the slots 56, 56a and 56b of the side member 16. The Idler roller 52 includes an axel shaft 58 having a square in cross-section portion 60 formed on each of the opposite ends thereof. The square portions 60 at the opposite ends of the axel shaft 58 are each shown as being disposed in the aligned pair of the square slots 54 and 56 provided in the side members 14 and 16, and fit snuggly therein to fix the shaft 58 against rotation. The idler roller 52 further includes a roller body 62 which is mounted concentrically on the axel shaft 58 and is rotatable about that shaft. The roller body 62 is similar to the previously described drive roller body 50 in that it is preferably made of rubber or other suitable material that will result in a relatively high coefficient of friction between the roller body 62 and the containerized product being mixed in the blender 10.

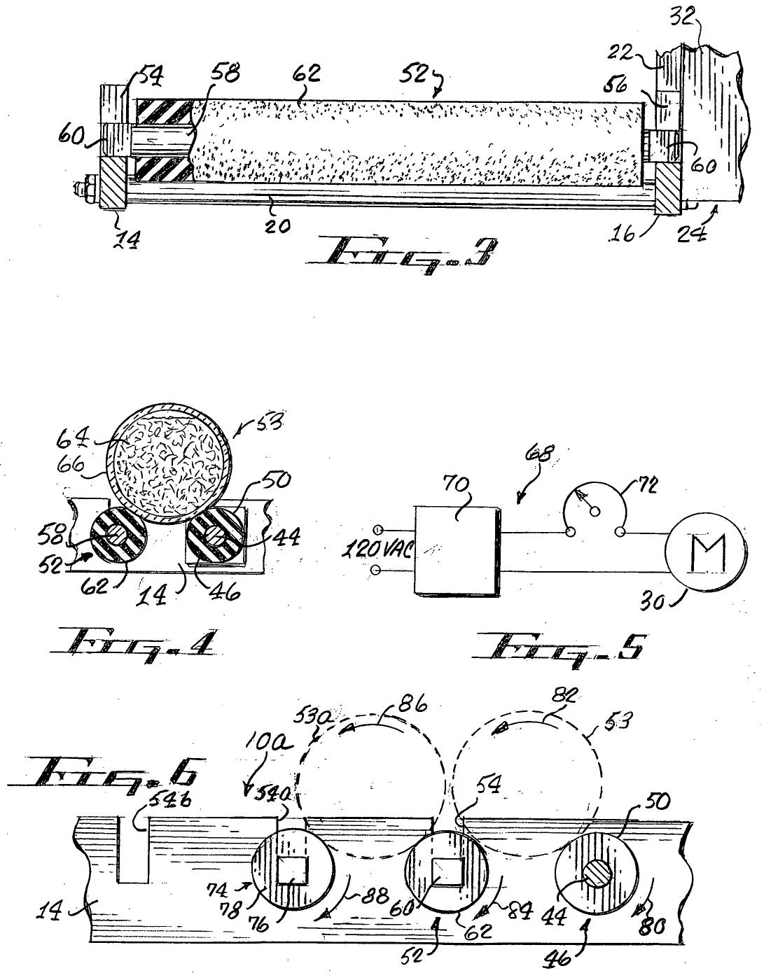

As described above, the drive roller 46 and the idler roller 52 are mounted in parallel spaced apart positions relative to each other in the housing 12 so that a containerized product to be mixed as indicated generally at 53 in FIG. 4 is in resting bearing engagement on the two rollers. Rotational driving of the drive roller 46 by the drive mechanism 24 will, as a result of friction, produce a rotary movement of the containerized product 53. In that the containerized product 53 is also in engagement with the idler roller 52, friction between the containerized product 53 and the idler roller will result in rotation of the idler roller.

It will be understood that the blender 10 can be used to mix any containerized non-homogenized product such as some salad dressings, paint and the like. Although the blender 10 can be used to mix a variety of products, it is particularly well suit for mixing the ingredients of non-homogenized peanut butter which is commonly referred to as natural peanut butter. The containerized product 53 is shown in FIG. 4 to contain natural peanut butter which is indicated by the reference numeral 64 and is packaged within a suitable jar 66.

FIG. 5 illustrates a power supply which is indicated generally by the reference numeral 68. The power supply 68 which is suitable for use in operation of the blender 10 includes a step down transformer/rectifier 70 which is connected to a source of electric power such as 120 VAC and will reduce and rectify that voltage to produce an output of 12 VDC which is applied through a rheostat 72 to the drive motor 30. The rheostat 72 is used to selectively further reduce the voltage applied to the motor 30 so that the speed of the motor can be adjusted to suit the viscosity of the products being mixed in the blender 10. A power supply identified as catalog number 273-029 having an output of from 3-12 VDC at a maximum of 1 A is suitable for this purpose and is available from retail establishments of Radio Shack. An alternate power supply could be employed such as that produced by the silicon rectifiers of a solar energy installation.

FIG. 6 shows a fragmentary portion of a modified blender 10a which is configured for simultaneous mixing of two containerized products 53 and 53a shown in dotted lines in this figure. In addition to the hereinbefore described drive roller 46 and idler roller 52, another idler roller 74 is mounted in a different pair of aligned square slots 54a and 56a (56a not shown in this figure) provided in the side members 14 and 16 of the housing 12. The additional idler roller 74 is identical to the previously described idler roller 52 and includes an axel shaft 76 with a roller body 78 mounted for rotation about the axel shaft. Driving of the drive roller 46 in the direction indicated by the arrow 80 will produce rotational driving of the containerized product 53 in the direction indicated by the arrow 82. Such rotation of the containerized product 53 will drive the idler roller 52 in the direction indicated by the arrow 84 and the idler roller 52 will in turn drive the containerized product 53a in the direction indicated by the arrow 86 and the containerized product 53a will drive the idler roller 74 in the direction of the arrow 88.

It will be appreciated that the blender 10 when configured as shown can be used to mix products contained in containers of different sizes. Containers that are smaller (not shown) than the container 53 shown in FIGS. 4 and 6, will sit down further between the drive roller 46 and Idler roller 52. Similarly, containers that are larger (not shown) will sit higher between the drive roller 46 and the idler roller 52. Further, the blender 10 can be reconfigured by moving the idler roller 52 out of the slots 54 and 56 and installing it in slots 54a and 54b for mixing products contained in much larger containers (not shown).

While the principles of the invention have now been made clear in the illustrated embodiment, many modifications will be obvious to those skilled in the art which do not depart from those principles. The appended claims are therefore intended to cover such modifications within the limits only of the true spirit and scope of the invention.

What I claim is:

1. A blender for mixing non-homogenized containerized products comprising:
a) a housing;
b) a drive mechanism having an output shaft, said drive mechanism being mounted on said housing and being operable to apply a rotary motion on the output shaft thereof;
c) a drive roller mounted in said housing and being coupled to the output shaft of said drive mechanism to be rotatably driven thereby;
d) an idler roller mounted in said housing and being free to rotate; and
e) said drive roller and said idler roller being in spaced apart parallel relationship with respect to each other and laying in a substantially horizontal attitude for supportingly receiving the product to be mixed and rotating that product for mixing thereof when said drive mechanism is operated.

2. A blender as claimed in claim 1 and further comprising:
a) said housing includes a spaced apart pair of side members; and
b) said drive mechanism being mounted on one of the side members of said housing.

3. A blender as claimed in claim 2 wherein said drive roller comprises:
a) a drive shaft one end of which is coupled to the output shaft of said drive mechanism proximate the one side member of said housing with the other end of said drive shaft being contained in a bearing provided in the other side member of said housing; and
b) a roller body mounted concentrically on the said drive shaft for rotation therewith, said roller body being formed of a material for frictionally engaging the containerized product to be mixed when it is supportingly received thereon for rotational driving of the product.

4. A blender as claimed in claim 1 and further comprising:
a) said housing includes a spaced apart pair of side members each having at least a first slot formed therein with the first slots formed in the side members being aligned with each other; and
b) said idler roller including,
i) an axel shaft the opposite ends of which are snugly mounted in different ones of the aligned first slots formed in the side members of said housing to fix the axel shaft against rotation,
ii) an idler body mounted concentrically on said axel shaft for rotation about said axel shaft, said idler body being formed of a a material for frictionally engaging the containerized product to be mixed when it is supportingly received thereon.

5. A blender as claimed in claim 4 wherein the spaced apart pair of side members of said housing each have at least one additional slot formed therein with the additional slots being aligned with each other and spaced from said first pair of aligned slots, the first pair of aligned slots and the additional pair of aligned slots formed in the side members of said housing all open upwardly to allow said idler roller to be removed from the first pair of slots and installed in the additional pair of slots.

6. A blender as claimed in claim 4 and further comprising:
a) the spaced apart pair of side members of said housing each having at least one additional slot formed therein with the additional slots aligned with each other and spaced from the first pair of aligned slots; and
b) a second idler roller including,
i) an axel shaft the opposite ends of which are snugly mounted in different ones of the aligned second slots formed in the side members of said housing to fix the axel shaft against rotation,
ii) an idler body mounted concentrically on said axel shaft for rotation about said axel shaft, said idler body being formed of a a material for frictionally engaging a second containerized product to be mixed when it is supportingly received thereon.

7. A blender as claimed in claim 1 wherein said drive mechanism comprises a variable speed gear motor for applying the rotary motion to the output shaft of said drive mechanism.

8. A blender as claimed in claim 7 and further comprising a power supply including means for producing an output voltage which is coupled to said variable speed gear motor through a rheostat by which the voltage applied to the variable speed gear motor can be selectively adjusted to alter the rotational output speed of the variable speed gear motor.

9. A blender as claimed in claim 7 and further comprising a power supply which includes a transformer/rectifier for receiving 120 VAC and producing a 12 VDC output which is coupled to said gear motor through a rheostat by which the voltage applied to the variable speed gear motor can be selectively adjusted to alter the rotational output speed of the variable speed gear motor.

10. A blender for mixing non-homogenized containerized natural peanut butter comprising:
a) a housing;
b) a drive mechanism having an output shaft, said drive mechanism being mounted on said housing and being operable to apply a rotary motion on the output shaft thereof:
c) a drive roller mounted in said housing and being coupled to the output shaft of said drive mechanism to be rotatably driven thereby;
d) an idler roller mounted in said housing and being free to rotate;
e) said drive roller and said idler roller being in spaced apart parallel relationship with respect to each other and laying in a substantially horizontal attitude; and
f) a container of non-homogenized natural peanut butter supportingly disposed on said drive roller and said idler roller for being rotatably driven by frictional engagement with said drive roller when said drive mechanism is operated to drive said drive roller.

11. A blender as claimed in claim 10 and further comprising:
a) said housing includes a spaced apart pair of side members; and
b) said drive mechanism being mounted on one of the side members of said housing.

12. A blender as claimed in claim 11 wherein said drive roller comprises:
a) a drive shaft one end of which is coupled to the output shaft of said drive mechanism proximate the one side member of said housing with the other end of said drive shaft being contained in a bearing provided in the other side member of said housing; and
b) a roller body mounted concentrically on the said drive shaft for rotation therewith, said roller body being formed of a material for frictionally engaging the containerized product to be mixed when it is supportingly received thereon for rotational driving of the product.

13. A blender as claimed in claim 10 and further comprising:
a) said housing includes a spaced apart pair of side members each having at least a first slot formed therein with the first slots formed in the side members being aligned with each other; and
b) said idler roller including,
i) an axel shaft the opposite ends of which are snugly mounted in different ones of the aligned first slots formed in the side members of said housing to fix the axel shaft against rotation;
ii) an idler body mounted concentrically on said axel shaft for rotation about the axel shaft, said idler body being formed of a a material for frictionally engaging the containerized product to be mixed when it is supportingly received thereon.

14. A blender as claimed in claim 13 wherein the spaced apart pair of side members of said housing each have at least one additional slot formed therein with the additional slots being aligned with each other and spaced from said first pair of aligned slots, said first pair of aligned slots and said additional pair of aligned slots formed in the side members of said housing all open upwardly to allow said idler roller to be removed from the first pair of slots and installed in the additional pair of slots.

15. A blender as claimed in claim 13 and further comprising:
a) the spaced apart pair of side members of said housing each having at least one additional slot formed therein with the additional slots aligned with each other and spaced from the first pair of aligned slots; and
b) a second idler roller including,
i) an axel shaft the opposite ends of which are snugly mounted in different ones of the aligned second slots formed in the side members of said housing to fix the axel shaft against rotation,
ii) an idler body mounted concentrically on said axel shaft for rotation about said axel shaft, said idler body being formed of a a material for frictionally engaging a second containerized product to be mixed when it is supportingly received thereon.

16. A blender as claimed in claim 10 wherein said drive mechanism comprises a variable speed gear motor for applying the rotary motion to the output shaft of said drive mechanism.

17. A blender as claimed in claim 16 and further comprising a power supply including means for producing an output voltage which is coupled to said variable speed gear motor through a rheostat by which the voltage applied to the variable speed gear motor can be selectively adjusted to alter the rotational output speed of the variable speed gear motor.

18. A blender as claimed in claim 16 and further comprising a power supply which includes a transformer/rectifier for receiving 120 VAC and producing a 12 VDC output which is coupled to said gear motor through a rheostat by which the voltage applied to the variable speed gear motor can be selectively adjusted to alter the rotational output speed of the variable speed gear motor.
